(19) United States
(12) Patent Application Publication
(10) Pub. No.: US 2024/0227699 A1
(43) Pub. Date: Jul. 11, 2024

(54) License Plate Cover Assembly

(71) Applicants: Darrell Allen, Upper Marlboro, MD (US); Cyrene Allen, Upper Marlboro, MD (US)

(72) Inventors: Darrell Allen, Upper Marlboro, MD (US); Cyrene Allen, Upper Marlboro, MD (US)

(21) Appl. No.: 18/095,609

(22) Filed: Jan. 11, 2023

(51) Int. Cl. B60R 13/10; B60Q 1/56; B60R 16/033

(52) U.S. Cl. CPC B60R 13/105; B60Q 1/56; B60R 16/033

(57) ABSTRACT

A license plate cover assembly for enhancing visibility of a license plate in all conditions includes a license plate mount is attachable to a rear of a vehicle thereby facilitating a license plate to be retained on the vehicle. The license plate mount has a ledge extending over the license plate thereby shielding the license plate from snow and freezing rain to facilitate the license plate to be clearly visible at all times. A light emitter is attached to the ledge to emit light outwardly from the ledge. The light emitter is oriented to face the license plate to illuminate the license plate at night.

### CROSS-REFERENCE TO RELATED APPLICATIONS

### Statement Regarding Federally Sponsored Research or Development

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to license plate devices and more particularly pertains to a new license plate device for enhancing visibility of a license plate in all conditions. The device includes a license plate mount that is attachable to a rear of a vehicle. The device includes a ledge attached to the license plate mount to shield the license plate from snow and ice. The device includes a light emitter attached to the ledge for illuminating the license plate. The device includes a pair of solar panels and a battery for powering the light emitter.

### (2) Description of Related Art Including Information Disclosed Under 37 CFR 1.97 and 1.98

The prior art relates to license plate devices including a variety of license plate covers that comprise a translucent cover that is positionable over a license plate. The prior art discloses a license plate cover that includes a hinged cover that is comprised of a translucent material. The prior art discloses a variety of motorized license plate covers that positioning a license plate in various orientations. The prior art discloses license plate cover that includes a roof with a viewing window and a pair of gussets each with a viewing window. The prior art discloses a variety of license plate covers that each at least includes a light emitter for illuminating a license plate. In no instance does the prior art disclose a license plate cover that combines a ledge for shielding a license plate, a window for viewing the license plate and a light emitter for illuminating the license plate.

### BRIEF SUMMARY OF THE INVENTION

An embodiment of the disclosure meets the needs presented above by generally comprising a license plate mount is attachable to a rear of a vehicle thereby facilitating a license plate to be retained on the vehicle. The license plate mount has a ledge extending over the license plate thereby shielding the license plate from snow and freezing rain to facilitate the license plate to be clearly visible at all times. A light emitter is attached to the ledge to emit light outwardly from the ledge. The light emitter is oriented to face the license plate to illuminate the license plate at night.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a phantom perspective view of a license plate cover assembly according to an embodiment of the disclosure.

FIG. 2 is a front view of an embodiment of the disclosure.

FIG. 3 is a top view of an embodiment of the disclosure.

FIG. 4 is a left view of an embodiment of the disclosure.

FIG. 5 is a perspective in-use view of an embodiment of the disclosure.

### DETAILED DESCRIPTION OF THE INVENTION

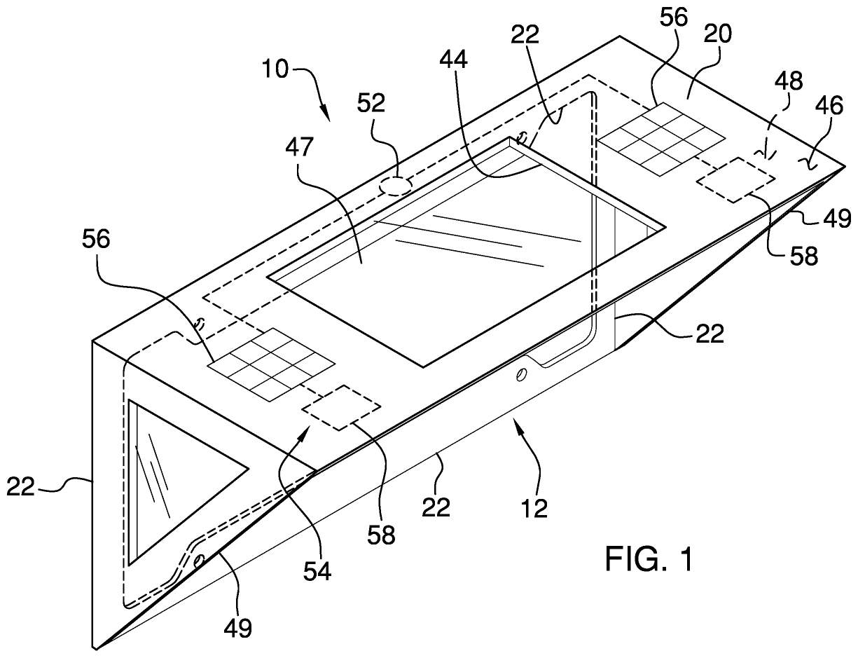

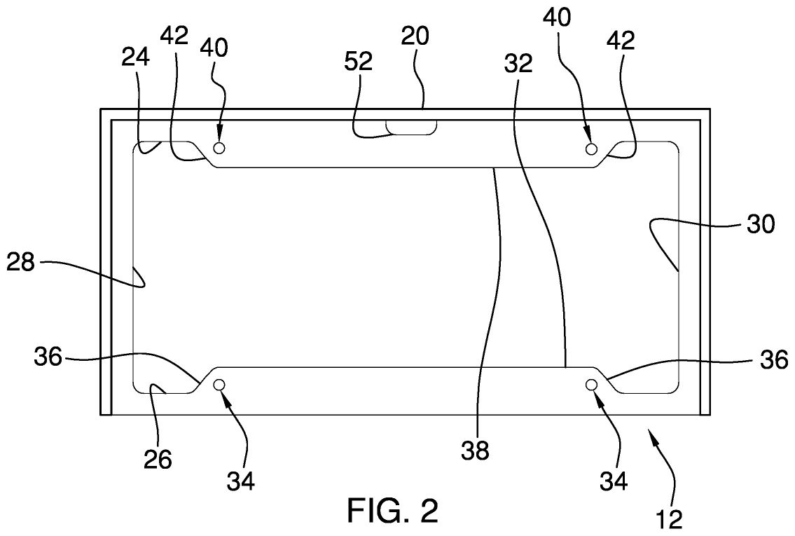

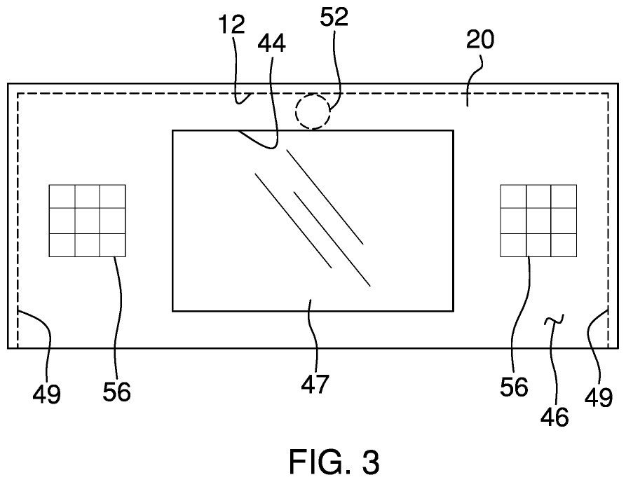

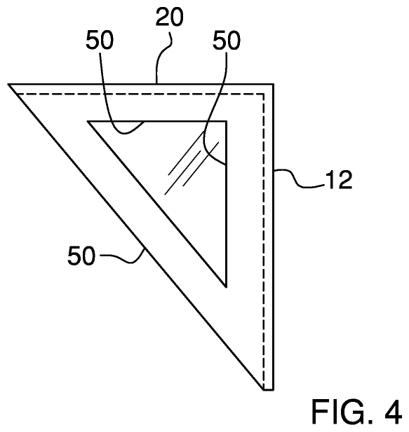

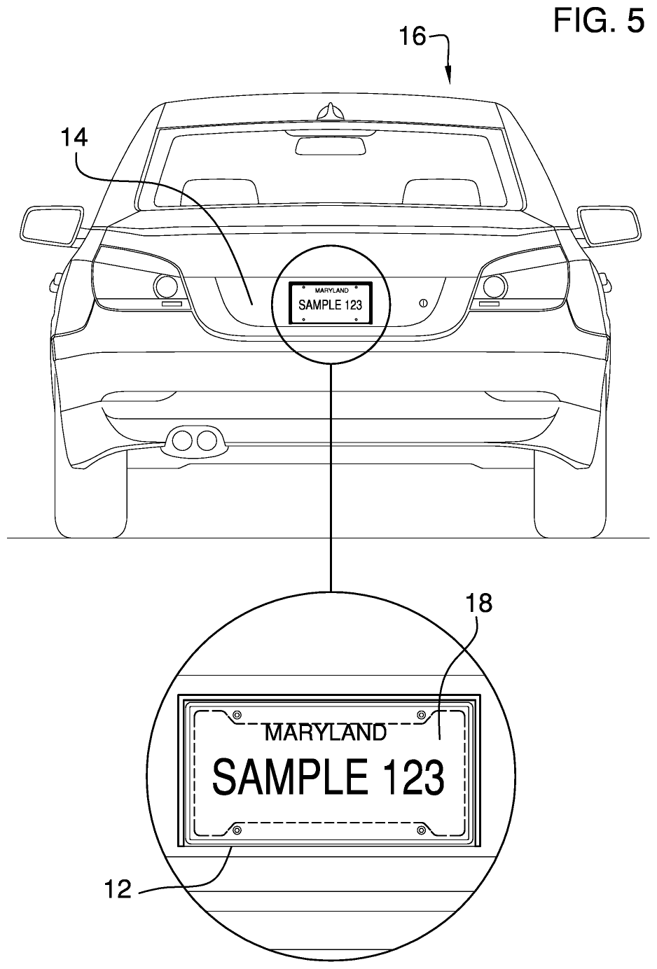

With reference now to the drawings, and in particular to FIGS. 1 through 5 thereof, a new license plate device embodying the principles and concepts of an embodiment of the disclosure and generally designated by the reference numeral 10 will be described.

As best illustrated in FIGS. 1 through 5, the license plate cover assembly 10 generally comprises a license plate mount 12 that is attachable to a rear 14 of a vehicle 16 thereby facilitating a license plate 18 to be retained on the vehicle 16. The vehicle 16 may be a passenger vehicle, a cargo vehicle or any other type of motorized vehicle that is licensed to travel on public roadways. Furthermore, the license plate 18 may be a license plate of any conventional design that is issued by a government agency. The license plate mount 12 has a ledge 20 which extends over the license plate 18 thereby shielding the license plate 18 from snow and freezing rain. In this way the ledge 20 facilitates the license plate 18 to be clearly visible at all times.

The license plate mount 12 comprises a plurality of members 22 that intersect each other at a perpendicular angle such that the plurality of members 22 defines a rectangle. The plurality of members 22 includes a top member 24, a bottom member 26, a first lateral member 28 and a second lateral member 30. The bottom member 26 has a prominence 32 extending toward the top member 24 and the prominence 32 extends along a substantial length of the bottom member 26. The bottom member 26 has a pair of first holes 34 each extending through the bottom member 26 such that each of the pair of first holes 34 accommodates a fastener for attaching the license plate mount 12 to the vehicle 16. Additionally, each of the pair of first holes 34 is located on the prominence 32 and each of the pair of first holes 34 is located adjacent to a respective one of a pair of terminal ends 36 of the prominence 32.

The top member 24 has a prominence 38 extending toward the bottom member 26 and the prominence 38 on the top member 24 extends along a substantial length of the top member 24. The top member 24 has a pair of second holes 40 each extending through the top member 24 such that each of the pair of second holes 40 accommodates a fastener for attaching the license plate mount 12 to the vehicle 16. Each of the pair of second holes 40 is located on the prominence 38 on the top member 24 and each of the pair of second holes 40 is located adjacent to a respective one of a pair of terminal ends 42 of the prominence 38 on the top member 24.

The ledge 20 extends away from the top member 24 of the license plate mount 12 and the ledge 20 extends along a full length of the top member 24. The ledge 20 has a hole 44 extending through a top surface 46 and a bottom surface 48 of the ledge 20 thereby facilitating the license plate 18 to be visible through the hole 44. Additionally, the hole 44 is centrally positioned on the ledge 20. A window 47 is integrated into the ledge 20 and the window 47 completely covers the hole. The window 47 is comprised of a translucent material thereby facilitating the license plate 18 to be visible through the window 47.

A pair of gussets 49 is provided and each of the pair of gussets 49 is attached between the bottom surface 48 of the ledge 20 and a respective one of the first lateral member 28 and the second lateral member 30. Each of the pair of gussets 49 comprises a plurality of intersecting members 50 that are oriented at angles with each other to define a triangle such that each of the pair of gussets 49 facilitates light to pass through the pair of gussets 49 thereby enhancing visibility of the license plate 18. A light emitter 52 is attached to the ledge 20 to emit light outwardly from the ledge 20 and the light emitter 52 is oriented to face the license plate 18 for illuminating the license plate 18 at night. The light emitter 52 is positioned on the bottom surface of the ledge 20 and the light emitter 52 is positioned between the hole in the ledge 20 and the top member 24 of the license plate mount 12. Additionally, the light emitter 52 may comprise a light emitting diode or other type of electronic light emitter.

A power supply 54 is integrated into the license plate mount 12 and the power supply 54 is electrically coupled to the light emitter 52. The power supply 54 comprises a pair of solar panels 56 and each of the pair of solar panels 56 is attached to the top surface 46 of the ledge 20 such that the pair of solar panels 56 is exposed to sunlight. The power supply 54 includes at least one battery 58 that is integrated into the license plate mount 12. The at least one battery 58 is electrically coupled to the pair of solar panels 56 such that the pair of solar panels 56 charges the at least one battery 58 and the at least one battery 58 is electrically coupled to the light emitter 52.

In use, the license plate mount 12 is attached to the rear 14 of the vehicle 16 to mount the license plate 18 to the rear 14 of the vehicle 16. The ledge 20 protects the license plate 18 from snow and freezing rain thereby inhibiting snow and ice from building up on the license plate 18. In this way the license plate 18 is clearly visible during winter months. The light emitter 52 emits light to illuminate the license plate 18 during night time hours. In this way the license plate 18 is clearly visible at all times and in all weather conditions.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A license plate cover assembly to inhibit ice and snow from collecting on a license plate of a vehicle, said assembly comprising:
a license plate mount being attachable to a rear of a vehicle thereby facilitating a license plate to be retained on the vehicle, said license plate mount having a ledge extending over the license plate thereby shielding the license plate from snow and freezing rain wherein said ledge is configured to facilitate the license plate to be clearly visible at all times; and
a light emitter being attached to said ledge wherein said light emitter is configured to emit light outwardly from said ledge, said light emitter being oriented to face the license plate wherein said light emitter is configured to illuminate the license plate at night.

2. The assembly according to claim 1, wherein:
said license plate mount comprises a plurality of members intersecting each other at a perpendicular angle such that said plurality of members defines a rectangle, said plurality of members including a top member, a bottom member, a first lateral member and a second lateral member;
said bottom member has a prominence extending toward said top member, said prominence extending along a substantial length of said bottom member, said bottom member having a pair of first holes each extending through said bottom member such that each of said pair of first holes accommodates a fastener for attaching the license plate mount to the vehicle, each of said pair of first holes being located on said prominence, each of said pair of first holes being located adjacent to a respective one of a pair of terminal ends of said prominence;
said top member has a prominence extending toward said bottom member, said prominence on said top member extending along a substantial length of said top member, said top member having a pair of second holes each extending through said top member such that each of said pair of second holes accommodates a fastener for attaching the license plate mount to the vehicle, each of said pair of second holes being located on said prominence on said top member, each of said pair of second holes being located adjacent to a respective one of a pair of terminal ends of said prominence on said top member; and
said ledge extends away from said top member of said license plate mount, said ledge extending along a full length of said top member.

3. The assembly according to claim 2, wherein:
said ledge has a hole extending through a top surface and a bottom surface of said ledge thereby facilitating the license plate to be visible through said hole, said hole being centrally positioned on said ledge; and
said assembly includes a window being integrated into said ledge, said window completely covering said hole, said window being comprised of a translucent material thereby facilitating the license plate to be visible through said window.

4. The assembly according to claim 2, further comprising a pair of gussets, each of said pair of gussets being attached between said bottom surface of said ledge and a respective one of said first lateral member and said second lateral member, each of said pair of gussets comprising a plurality of intersecting members being oriented at angles with each other to define a triangle such that each of said pair of gussets facilitates light to pass through said pair of gussets thereby enhancing visibility of the license plate.

5. The assembly according to claim 3, wherein said light emitter is positioned on said bottom surface of said ledge, said light emitter being positioned between said hole in said ledge and said top member of said license plate mount.

6. The assembly according to claim 3, further comprising a power supply being integrated into said license plate mount, said power supply being electrically coupled to said light emitter, said power supply comprising:
a pair of solar panels, each of said pair of solar panels being attached to said top surface of said ledge wherein said pair of solar panels is configured to be exposed to sunlight; and
at least one battery being integrated into said license plate mount, said at least one battery being electrically coupled to said pair of solar panels such that said pair of solar panels charges said at least one battery, said at least one battery being electrically coupled to said light emitter.

7. A license plate cover assembly to inhibit ice and snow from collecting on a license plate of a vehicle, said assembly comprising:
a license plate mount being attachable to a rear of a vehicle thereby facilitating a license plate to be retained on the vehicle, said license plate mount having a ledge extending over the license plate thereby shielding the license plate from snow and freezing rain wherein said ledge is configured to facilitate the license plate to be clearly visible at all times, said license plate mount comprising a plurality of members intersecting each other at a perpendicular angle such that said plurality of members defines a rectangle, said plurality of members including a top member, a bottom member, a first lateral member and a second lateral member, said bottom member having a prominence extending toward said top member, said prominence extending along a substantial length of said bottom member, said bottom member having a pair of first holes each extending through said bottom member such that each of said pair of first holes accommodates a fastener for attaching the license plate mount to the vehicle, each of said pair of first holes being located on said prominence, each of said pair of first holes being located adjacent to a respective one of a pair of terminal ends of said prominence, said top member having a prominence extending toward said bottom member, said prominence on said top member extending along a substantial length of said top member, said top member having a pair of second holes each extending through said top member such that each of said pair of second holes accommodates a fastener for attaching the license plate mount to the vehicle, each of said pair of second holes being located on said prominence on said top member, each of said pair of second holes being located adjacent to a respective one of a pair of terminal ends of said prominence on said top member, said ledge extending away from said top member of said license plate mount, said ledge extending along a full length of said top member, said ledge having a hole extending through a top surface and a bottom surface of said ledge thereby facilitating the license plate to be visible through said hole, said hole being centrally positioned on said ledge;
a window being integrated into said ledge, said window completely covering said hole, said window being comprised of a translucent material thereby facilitating the license plate to be visible through said window;
a pair of gussets, each of said pair of gussets being attached between said bottom surface of said ledge and a respective one of said first lateral member and said second lateral member, each of said pair of gussets comprising a plurality of intersecting members being oriented with each other to define a triangle such that each of said pair of gussets facilitates light to pass through said pair of gussets thereby enhancing visibility of the license plate;
a light emitter being attached to said ledge wherein said light emitter is configured to emit light outwardly from said ledge, said light emitter being oriented to face the license plate wherein said light emitter is configured to illuminate the license plate at night, said light emitter being positioned on said bottom surface of said ledge, said light emitter being positioned between said hole in said ledge and said top member of said license plate mount; and
a power supply being integrated into said license plate mount, said power supply being electrically coupled to said light emitter, said power supply comprising:
a pair of solar panels, each of said pair of solar panels being attached to said top surface of said ledge wherein said pair of solar panels is configured to be exposed to sunlight; and
at least one battery being integrated into said license plate mount, said at least one battery being electrically coupled to said pair of solar panels such that said pair of solar panels charges said at least one battery, said at least one battery being electrically coupled to said light emitter.
